(19) United States
(12) Patent Application Publication
(10) Pub. No.: US 2010/0211213 A1
(43) Pub. Date: Aug. 19, 2010

(54) DOCUMENT DISPOSAL MANAGEMENT SYSTEM AND METHOD OF THE SAME

(75) Inventor: Daisuke ISHIKAWA, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/695,674

(22) Filed: Jan. 28, 2010

Related U.S. Application Data
(60) Provisional application No. 61/153,215, filed on Feb. 17, 2009.

(51) Int. Cl. G06F 7/00

(52) U.S. Cl. 700/223; 700/228

(57) ABSTRACT

A document disposal management system of an example of the invention includes: a plurality of disposal document input units to which a document to be disposed of is input; a document transport mechanism unit which transports the input document in the disposal document input units; a disposal process instructing terminal which is provided in each disposal document input unit and instructs a kind of the document to be disposed of and a process treatment thereof; and a document processing mechanism unit which deposits the document transported from the document transport mechanism unit so as to be disposed of according to an instruction of the disposal process instructing terminal.

### CROSS-REFERENCE TO RELATED APPLICATION

This application is based upon and claims the benefit of priority from U.S. provisional application 61/153,215, filed on Feb. 17, 2009, the entire contents of each of which are incorporated herein by reference.

### TECHNICAL FIELD

The present invention relates to a document disposal management system and, more particularly, to a disposal management system of confidential documents or unnecessary documents and a method of the same, which can be freely instructed and controlled by plural users close at hand.

### BACKGROUND

Conventionally, shredders are widely used as a tool for disposing of documents such as confidential documents. However, when plural persons want to use the shredder, the space must be widened if a shredder is to be provided for each person. Therefore, when only one machine is provided, each person goes to the place where the shredder is provided every time a document is disposed of and inputs the document in the shredder, which is very inconvenient.

In addition, even though a confidential document necessary to be kept secret from the outside is disposed of, the confidential document may be handled securely and left as paper in some cases. In addition, instead of paper, the document may be computerized and left in some cases. In addition, when the confidential document is disposed of without keeping a record thereof, in the future it will be impossible to confirm whether or not the document has been surely disposed of.

A confidential document management system is known, which includes a scanner-attached shredder for scanning the front and rear surfaces of only a confidential document before the confidential document is shredded and disposed of and storing the image information thereof, a plurality of clients each having the shredder, and a central system (JP-A-2009-11942).

Even in the case of a general document for disposal (an unnecessary document), a record of the disposal may be required so as to confirm the disposal after the document for disposal has been disposed of.

Furthermore, a paper classifying apparatus is known which, since the document paper cannot be reused after shredding, classifies documents into plain paper and thermal paper and only shreds the thermal paper in order to reuse the paper as much as possible (JP-A-2000-88769, FIG. 9).

In this manner, even though the word disposal is used in reference to the document, there are various methods in which the document can be processed as a confidential document or an unnecessary document as needed.

The invention is made in consideration of the above circumstances, and provides a document disposal management system and a method of the same, in which each person working on a desk can specifically and effectively instruct the disposal of documents at hand as confidential documents or unnecessary documents according to personal preference without difficulty.

### SUMMARY

According to an aspect of the invention, there is provided a document disposal management system which includes: a plurality of disposal document input units to which a document to be disposed of is input; a document transport mechanism unit which transports the input document in the disposal document input units; a disposal process instructing terminal which is provided in each disposal document input unit and instructs a kind of the document to be disposed and a process treatment thereof; and a document processing mechanism unit which deposits the document transported by the document transport mechanism unit so as to be disposed by an instruction of the disposal process instructing terminal.

According to another aspect of the invention, there is provided a document disposal management system comprising: a plurality of disposal document input units to which a confidential document and an unnecessary document as documents to be disposed of are selectively input; a document transport mechanism unit which transports the confidential document and the unnecessary document input in the disposal document input units; a disposal process instructing terminal which is a personal computer provided on each of the disposal document input units and instructs the kind of a document to be disposed of and a process treatment thereof, the disposal process instructing terminal displaying the confidential document and the unnecessary document as the kinds of documents for disposal on a display unit thereof, and the kind of the document for disposal being designated by selecting and inputting one of the documents; a scanning unit which is provided in the disposal document input units and scans the document input in the disposal document input units; a computerized document storage unit which stores a computerized document obtained by scanning the document using the scanning unit, when options of whether the computerization is necessary or unnecessary being displayed on the display unit as the process treatment of the document to be disposed of and the option that the computerization is necessary is selected and input, the computerized document scanned by the scanning unit being stored in the computerized document storage unit; and a document processing mechanism unit which classifies the documents transported by the document transport mechanism unit into confidential documents and unnecessary documents and deposits the classified documents according to an instruction of the disposal process instructing terminal.

According to still another aspect of the invention, there is provided a document disposal management method which includes: when a document to be disposed of is input to anyone of a plurality of disposal document input units, transporting the document in the disposal document input unit to a document transport mechanism unit; and when the kind of the document to be disposed and a process treatment thereof are instructed by a disposal process instructing terminal provided on each of the disposal document input units, depositing the document transported by the document transport mechanism unit in order to be disposed in a document processing mechanism unit according to an instruction of the disposal process instructing terminal.

### DESCRIPTION OF THE DRAWINGS

FIG. 1 is a perspective view illustrating a document disposal management system according to an embodiment of the invention.

FIG. 2 is a cross-sectional view illustrating a structure of a document input box which is used in the embodiment shown in FIG. 1.

FIG. 3 is a top view of the embodiment shown in FIG. 1.

FIG. 4 is a diagram illustrating an electrical configuration of the embodiment shown in FIG. 1.

FIG. 5 is a flow chart illustrating an operation of the document disposal management system according to the embodiment of the invention.

FIG. 6 is a diagram illustrating an example of a screen in which a document processing method is selected when the document is a confidential document in the document disposal management system of the embodiment of the invention.

FIG. 7 is a diagram illustrating an example of a screen in which a document processing method is selected when the document is an unnecessary document in the document disposal management system of the embodiment of the invention.

### DETAILED DESCRIPTION

Hereinafter, an embodiment of a document disposal management system according to the invention will be described with reference to the drawings.

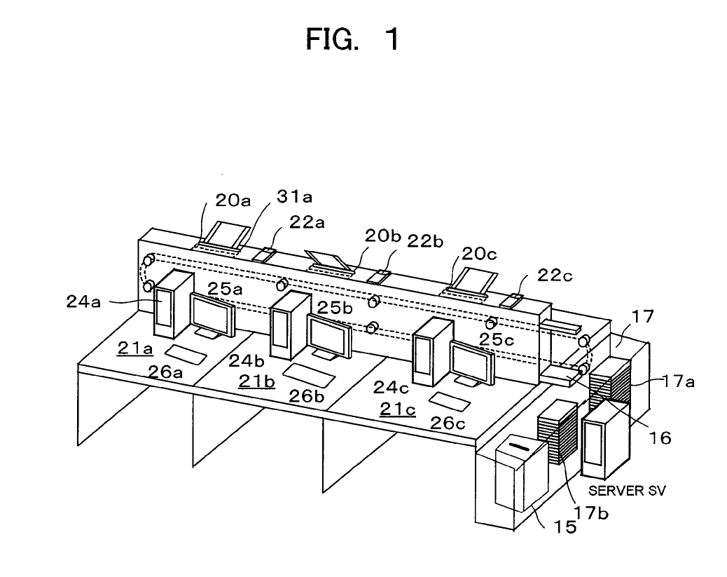

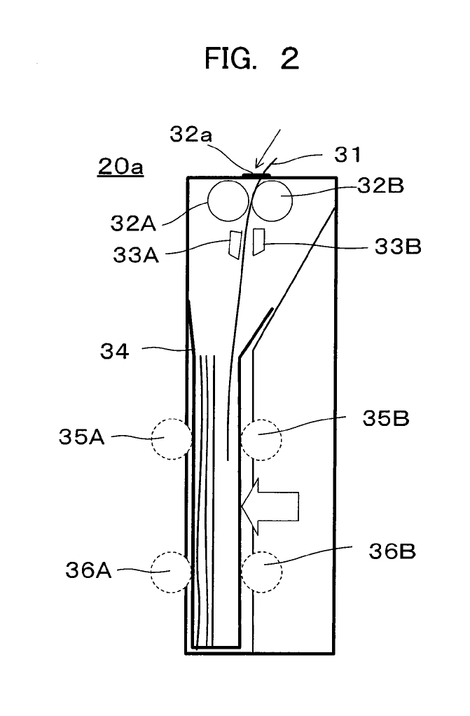

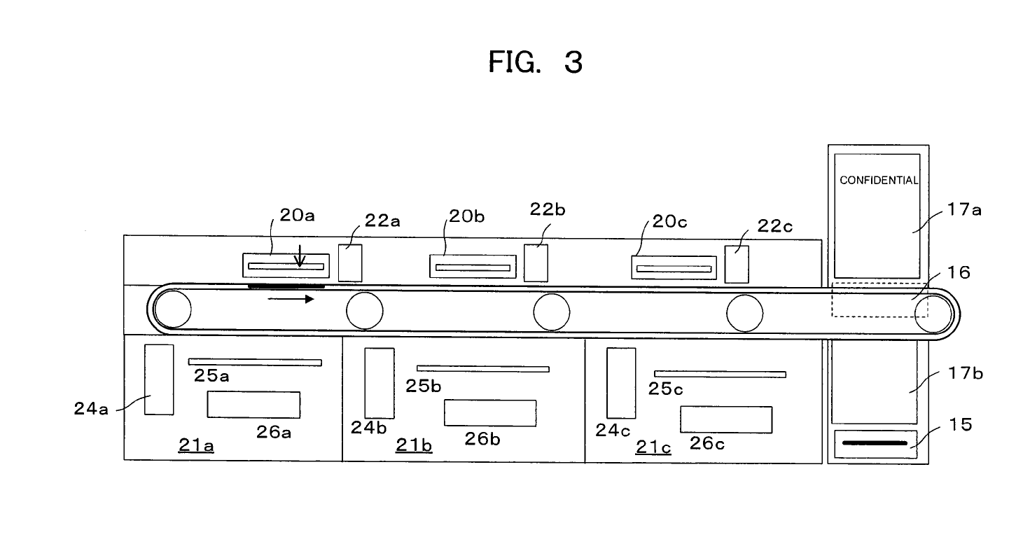

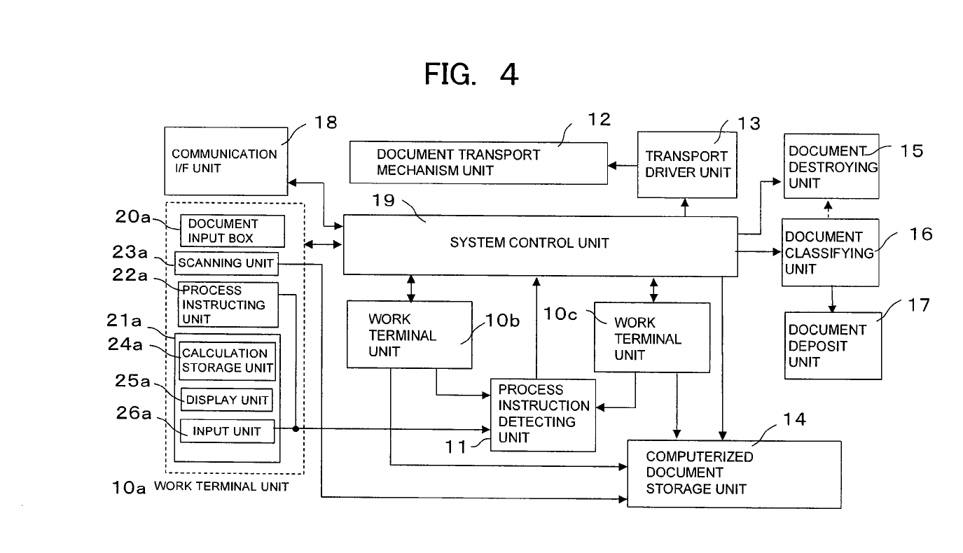

FIG. 1 shows a conceptual diagram of the entire document disposal management system according to the embodiment of the invention. FIG. 2 shows a cross-sectional view of a transport box of a document for disposal which is used in the system. FIG. 3 shows a top view of the embodiment shown in FIG. 1. In addition, FIG. 4 shows an electrical configuration of the embodiment.

The document disposal management system includes three work terminal units 10a, 10b, and 10c, a process instruction detecting unit 11 which detects an instruction of a disposal process from each of these work terminal units, a document transport mechanism unit 12 which transports the document for disposal, a transport driver unit 13 which controls the document transport mechanism unit 12 to be driven, a computerized document storage unit 14 which stores confidential documents computerized by instruction from the work terminal unit, a document destroying unit 15 which destroys the transported confidential document, a document classifying unit 16 which classifies the documents into confidential documents and unnecessary documents, a document deposit unit 17 which deposits the classified documents, a communication interfacing (I/F) unit 18 which carries out communication with the outside, and a system control unit 19 which controls each of these components. In a server SV shown in FIG. 1, an electrical control unit such as the system control unit 19 or the transport driver unit 13 is mounted. Here, the document destroying unit 15, the document classifying unit 16, and the document deposit unit 17 are collectively referred to as the document processing mechanism unit.

The work terminal unit 10a includes a document input box 20a, a computer 21a, a process instructing unit 22a, and a scanning unit 23a. In the document input box 20a, for example, a line scanner is provided as the scanning unit 23a. The computer 21a is a personal computer which includes a calculation storage unit 24a, a display unit 25a, and an input unit 26a, and which is generally used on a desk for business use.

The work terminal units 10b and 10c are similarly configured as those of the work terminal unit 10a. In FIG. 1, there are illustrated document input boxes 20b and 20c, process instructing units 22b and 22c, calculation storage units 24b and 24c of computers 21b and 21c, display units 25b and 25c, and input units 26b and 26c of the work terminal units 10b and 10c.

Operators using the desk of the work terminal units 10a, 10b, and 10c generally use the computers 21a, 21b, and 21c to work. Since the disposal processes on the work terminals 10a, 10b, and 10c are similar to one another, the disposal process of the work terminal unit 10a will be described.

As shown in FIG. 2, the document input box 20a includes a pair of rollers 32A and 32B which are provided just below an inlet 32a provided thereon, line scanners 33A and 33B, for example, which scan a document passed through the rollers 32A and 32B, a portion which is provided below the scanners and through which a transport box 34 is movable in a horizontal direction. The line scanners 33A and 33B are provided below the rollers 32A and 32B so as to be aligned in a direction perpendicular to an input direction of a document. The transport box 34 is typically provided on the right side of FIG. 1, detects an input start of a document to be disposed, and moves to a position of the document input box in which the document is being input. For example, a stepping motor is used in order to move the transport box.

When being input from the document inlet 32a, a document for disposal 31 is pulled down to the document input box 20a by the rollers 32A and 32B. Both surfaces of the pulled document are scanned as images by the pair of the line scanners 33A and 33B. After the contents are obtained as image data (computerized document images), the image data is transmitted to the computerized document storage unit 14 shown in FIG. 4. The document drops into the transport box 34 which comes thereto, and the transport box 34 containing the document is transported in a manner to be described later. Rollers 35A and 35B and rollers 36A and 36B show a transport mechanism. In order to reduce the volume of the transport box 34, pressure is applied from the surface coming into contact with the rollers 35B and 36B in the arrow direction.

The transport box 34, the rollers 35A and 35B, and the rollers 36A and 36B are included in the document transport mechanism unit 12 shown in FIG. 4, which are controlled by the transport driver unit 13 so as to be transported. According to the instruction of the kind of document and the process treatment thereof, the documents in the transport box 34 which is transported are mechanically destroyed, for example, by a shredder, or chemically destroyed by melting in the document destroying unit 15, or the documents are classified by the document classifying unit 16 so as to be deposited as confidential documents or documents for disposal in the document deposit unit 17. When the document is destroyed in the system, the secrecy increases; however, on the other hand, the equipment such as the shredder becomes large, so that the system increases in size. In addition, when the document is destroyed by the shredder, it is difficult to reuse the document. On the other hand, when the document for disposal is temporarily deposited and transported to the outside, the secrecy is not particularly high, but the document may be easily and advantageously reused.

The instruction regarding the kind of the document and the process treatment thereof, that is, the instruction regarding which kind of document and by which process the document for disposal is to be processed is typically displayed as options on the screen of the display unit 25a of the computer 21a which is used for work. Using the input unit 26a, for example, by moving the pointer of a mouse on the display screen, the option to be carried out is clicked, so that the instruction can be selectively carried out.

In addition, the instruction can be carried out by the process instructing unit 22a which is provided as a dedicated terminal or a general purpose terminal. Here, the instruction regarding the kind of the document and the process treatment thereof will be described when the computer 21a is used.

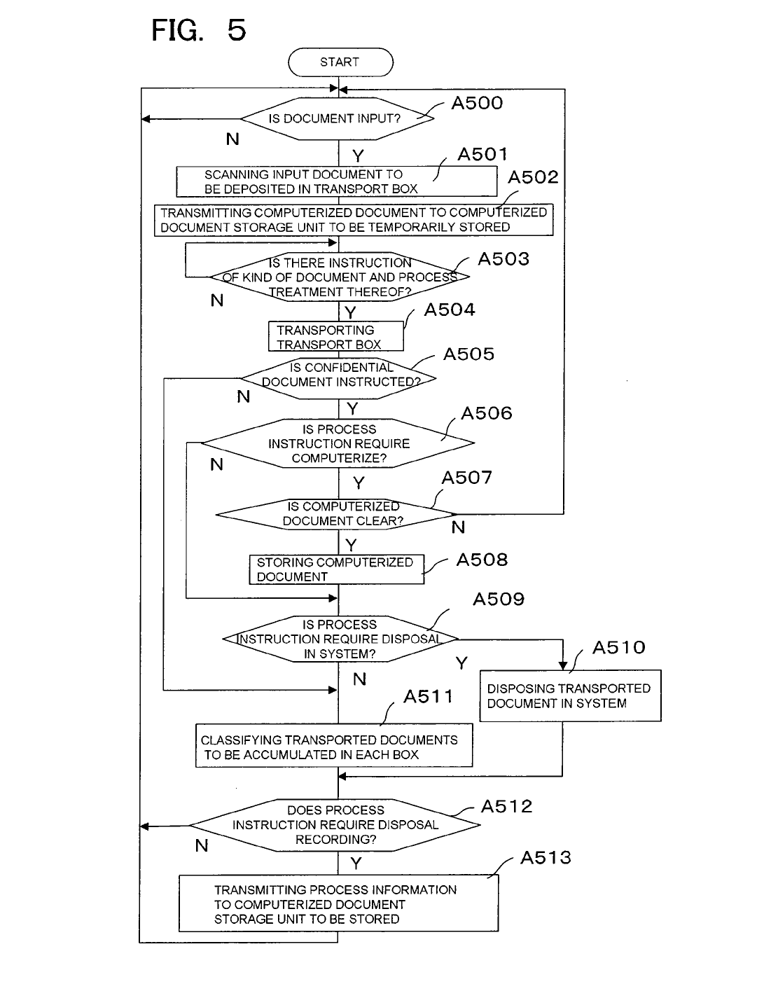

The operation of the document disposal management system of the embodiment will be described with reference to FIG. 5. First, when an operator positioned on the work terminal unit 10a inputs a document for disposal into the document input box 20a, a detecting unit (not shown) detects that the document is input in Act A500. The transport box is transported under the document input box which is positioned on the detected position, and the procedure proceeds to Act A501. The document 31 is scanned by the line scanners 33A and 33B of the scanning unit 23a which is provided in the document input box 20a and then drops into the transport box 34. The image data (computerized document) obtained by scanning the document is transferred to the computerized document storage unit 14 so as to be temporarily stored (Act A502).

In the subsequent Act A503, it is detected whether or not there is an instruction regarding the kind of the document and the process treatment thereof. The operator checks a disposal instruction screen on the screen of the display unit (monitor) 25a of the computer 21a, and clicks a specific position on the display screen using the input unit 26a, for example, a mouse, so as to carry out the instruction.

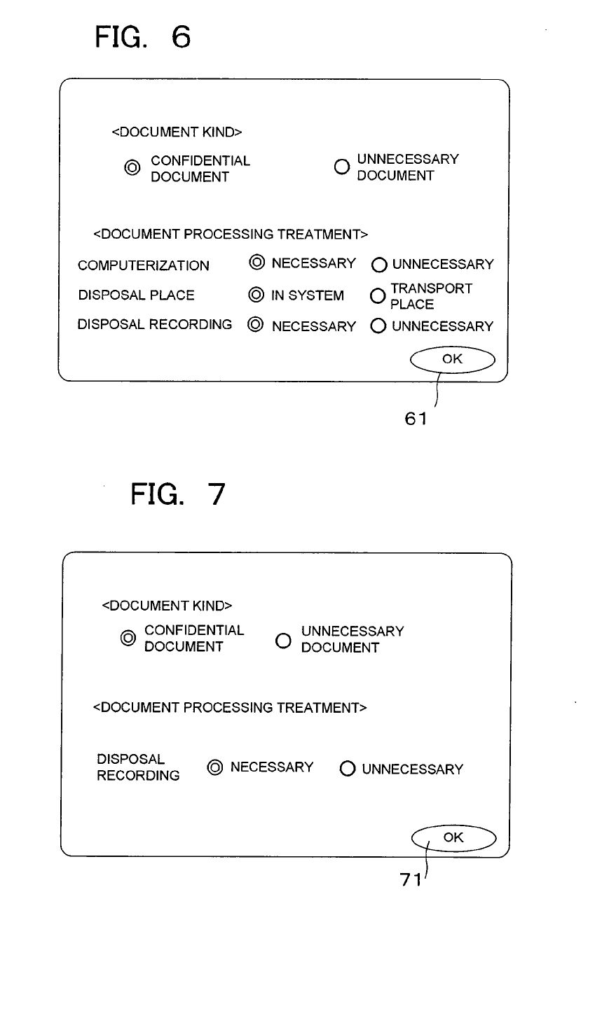

FIGS. 6 and 7 show an example of a disposal instruction screen. FIG. 6 is a display example when the document for disposal is a confidential document. FIG. 7 is a display example when the document for disposal is an unnecessary document. When the document for disposal is a confidential document, as the instruction method of the document, it can be instructed whether or not the document is computerized, the disposal place of the document, that is, whether the disposal of the document is carried out in the system or the document is transported and disposed of outside, and whether or not a record of the disposal is necessary. FIG. 6 shows an input example when the selection of a confidential document is instructed, the computerization as the process treatment of the document is instructed as unnecessary, the disposal place is instructed as a transport place, and a record of the disposal is instructed as unnecessary.

On the other hand, when the document for disposal is an unnecessary document, as shown in FIG. 7, when the unnecessary document is selected, only the recording of disposal is displayed on the screen as the process treatment of the document so as to be selected as necessary or unnecessary. FIG. 7 is an input example when the unnecessary document is selected and the disposal recording is set as unnecessary.

Further, in Act A503, the kind of the document or the method of the disposal process is instructed in the screen. However, the kind of the document or the method of the disposal process is printed to the document to be disposed of in advance, for example, with a QR code. The information is recognized, for example, when the document is scanned by the scanning unit. On the basis of the recognized information, the kind of the document or the method of the disposal process may be instructed. In this case, a portion in which the printed information such as the QR code is read becomes a disposal process instructing terminal.

When the instructions are completed in these screens, OK buttons 61 and 71 are clicked. Then, in Act A503, it is detected that the instruction of the process treatment is completed, and the procedure proceeds to Act A504. In Act A504, the transport box containing the documents for disposal is transported to the upper right side of FIG. 1.

In Act A505, it is detected whether or not a document instructed to be disposed of is a confidential document. When the document is instructed as a confidential document, the procedure proceeds to Act A506. In Act A506, it is detected whether or not it has been instructed that the computerization is necessary as the process treatment. When the instruction of the computerization has been made, the procedure proceeds to Act A507.

In Act A507, the image scanned in Act A502 is displayed on the display unit 25a of the computer 21a, for checking whether or not the image is unclear. When the scanned image is unclear, the previously input document for disposal is extracted, and the procedure returns to Act A500. The extracted document is input to the document input box once more, and the procedure is repeated until a clear image is obtained. At this time, the procedure may skip from Act A502 to Act A506.

When the scanned image is clear, the procedure proceeds to Act A508. The image data (computerized document) is stored in the computerized document storage unit 14 for reading thereafter.

In Act A509, it is detected whether or not the instruction of the disposal place in the process treatment carried out in Act A503 is disposal in the system. When the instruction is made to dispose of the document in the system, the procedure proceeds to Act A510. The transported document is physically destroyed in the system, for example, in the document destroying unit 15 by the shredder. The document may be chemically destroyed by being melted, for example.

When the documents are destroyed at a transport place instead of inside the system, the procedure proceeds from Act A509 to Act A511. The transported documents are classified by the document classifying unit 16, the documents are accumulated in a confidential document box 17a and an unnecessary document box 17b, respectively, which are provided in the document deposit unit 17. In this case, since the document for disposal is set to the confidential document in Act A505, the documents are accumulated in the confidential document box 17a and deposited therein.

When the computerization is unnecessary in Act A506, the procedure proceeds to Act A509. Then, it is detected whether or not the document is instructed to be disposed of in the system.

In Act A505, when the document for disposal is not a confidential document, that is, an unnecessary document, the procedure proceeds to Act A511 described above. After being classified by the document classifying unit 16, the documents for disposal are accumulated in the unnecessary document box 17b. When being disposed of, the documents for disposal are extracted from the unnecessary document box 17b and destroyed at a transport place.

In the next Act A512, it is detected whether or not the disposal recording of the process treatment is necessary. When the disposal recording is necessary, the procedure proceeds to Act A513. Process histories such as the disposal method and the disposal date and time are sent to the computerized document storage unit 14 so as to be stored.

Here, the input instruction which is carried out by the computer 21a as shown in FIG. 6 will be specifically described. In this case, in Act A505, in which it is detected whether or not the document for disposal is a confidential document, since the document for disposal is a confidential document, the procedure proceeds to Act A506. In the input example shown in FIG. 6, since the computerization is unnecessary, the procedure proceeds from Act A506 to Act A509. It is detected whether or not the disposal is carried out in the system. When the disposal shown in FIG. 6 is instructed, since the disposal is instructed to be carried out at a transport place, the process proceeds to Act A511. The documents for disposal are accumulated in the confidential document box 17a of the document deposit unit 17 via the document classifying unit 16 and securely deposited therein.

In the next Act A512, it is detected whether or not the disposal recording is necessary. In FIG. 6, since the disposal recording is unnecessary, the procedure returns to Act A500.

Next, a case where the disposal instruction shown in FIG. 7 is instructed will be described. The procedure from Act A500 to Act A504 is the same as that in the case described above.

In this case, since the document for disposal is an unnecessary document, Act A505, in which it is detected whether or not the document for disposal is a confidential document, corresponds to NO, and the procedure proceeds to Act A511. The documents for disposal are accumulated and deposited in the unnecessary document box 17b of the document deposit unit 17 via the document classifying unit 16. Thereafter, the accumulated unnecessary documents are transported to the outside and disposed of. Since the disposal recording is unnecessary, the procedure returns from Act A512 to Act A500.

The communication I/F unit 18 is built in, for example, the server SV, and receives control relating to the disposal instruction of the management system from the outside. Alternatively, the information relating to the disposal may be transported to an external system by communication therewith.

As shown in FIG. 6, in the above-mentioned embodiment, “computerization” can be selected as necessary or unnecessary in the instruction of the process treatment of the disposal. However, when the computerization is necessary, the method may be configured to select a part or the entirety of the document.

In the above-mentioned embodiment, the process treatment of the disposal is described as specifically instructed on the screen of the computer shown in FIG. 6 or FIG. 7. However, for example, a selection button as shown in FIG. 6 may be provided on a dedicated process instructing unit and the options may be selected, so that the kind of the document and the process treatment thereof may be instructed. The process instructing unit for instructing the kind of the document and the process treatment thereof and the above-mentioned input unit of the computer are collectively referred to as the disposal process instructing terminal.

In the above-mentioned embodiment, as shown in FIG. 6 or FIG. 7, a case where an operator specifically instructs the disposal is described. However, initial values when there is no instruction may be set. For example, when the confidential document is instructed, instructions are automatically set such that the computerization is unnecessary, the document for disposal is disposed of in the system and the disposal recording is necessary when the process treatment of the document is not instructed.

In addition, for example, when the unnecessary document is instructed, the instructions may be set such that the disposal recording is unnecessary when the process treatment of the document is not instructed. Therefore, when the initial values are set in advance, there is an advantage in that the operator does not need to specifically set the disposal process. The operator can set the initial values according to personal preference in advance so as to customize the system. Therefore, such a configuration is very convenient for the operator.

According to the embodiment of the invention, the operator of each computer can freely and specifically carry out the disposal instruction of the confidential document or the unnecessary document close at hand.

That is, it is possible to computerize the confidential document so as to either keep or not to keep the contents thereof. The operator can specifically instruct whether the document for disposal is to be destroyed in the system or at a transport place and whether a record of the disposal is to be kept or not to be kept. In addition, regarding the unnecessary document, the operator can freely set whether a record of the disposal is to be kept or not to be kept.

In the process treatment of the document for disposal, the options do not necessarily need to be provided as in the above-mentioned embodiment. In general, the process treatment in the case of an unnecessary document is effectively carried out in fewer stages than the process treatment of a confidential document. That is, the disposal process treatment of the unnecessary document can be simply selected and instructed. However, the disposal process treatment of the confidential document can be specifically selected and designated in detail, so that the disposal method can be effectively and properly selected.

As other options different from the above-mentioned embodiment, for example, the process treatment of the document may be set such that, in the case of the confidential document, the computerization is necessary, the disposal is carried out in the system, and the disposal recording is unnecessary, and in the case of the unnecessary document, the disposal recording is unnecessary. As a result, by inputting only the selection of the confidential document and the unnecessary document, the disposal process can be automatically carried out according to the kind of document.

Obviously, many, modifications and variations of this invention are possible in the light of the above teachings. It is therefore to be understood that within the scope of the appended claims, this invention may be practiced otherwise than as specification.

What is claimed is:

1. A document disposal management system comprising:
a plurality of disposal document input units to which a document to be disposed of is input;
a document transport mechanism unit which transports the input document in the disposal document input units;
a disposal process instructing terminal which is provided in each disposal document input unit and instructs a kind of the document to be disposed of and a process treatment thereof; and
a document processing mechanism unit which deposits the document transported by the document transport mechanism unit so as to be disposed of by an instruction of the disposal process instructing terminal.

2. The system according to claim 1,
wherein the instruction of the kind of the document instructed by the disposal process instructing terminal selects one of a confidential document and an unnecessary document.

3. The system according to claim 2,
wherein the number of options of a process treatment when the kind of the document instructed and selected by the disposal process instructing terminal is the confidential document is different from that in a case of the unnecessary document.

4. The system according to claim 3,
wherein the number of options of the process treatment when the kind of the document instructed and selected by the disposal process instructing terminal is the unnecessary document is larger than that in a case of the confidential document.

5. The system according to claim 4,
wherein the instruction of the process treatment instructed by the disposal process instructing terminal includes selection of whether computerization is necessary or unnecessary.

6. The system according to claim 5,
wherein the instruction of the process treatment instructed by the disposal process instructing terminal includes selection of whether disposal recording is necessary or unnecessary.

7. The system according to claim 6,
wherein the instruction of the process treatment instructed by the disposal process instructing terminal includes selection of whether a disposal place is in the system or a transport place.

8. The system according to claim 7,
wherein the instruction of the kind of the document and the process treatment thereof instructed by the disposal process instructing terminal is selected and input using a display unit and an input unit of a personal computer.

9. A document disposal management system comprising:
a plurality of disposal document input units to which a confidential document and an unnecessary document as documents to be disposed of are selectively input;
a document transport mechanism unit which transports the confidential document and the unnecessary document input in the disposal document input units;
a disposal process instructing terminal which is a personal computer provided on each of the disposal document input units and instructs the kind of a document to be disposed of and a process treatment thereof, the disposal process instructing terminal displaying the confidential document and the unnecessary document as the kinds of documents for disposal on a display unit thereof, and the kind of the document for disposal being designated by selecting and inputting one of the documents;
a scanning unit which is provided in the disposal document input units and scans the document input in the disposal document input units;
a computerized document storage unit which stores a computerized document obtained by scanning the document using the scanning unit, when options of whether the computerization is necessary or unnecessary being displayed on the display unit as the process treatment of the document to be disposed of and the option that the computerization is necessary is selected and input, the computerized document scanned by the scanning unit being stored in the computerized document storage unit; and
a document processing mechanism unit which classifies the documents transported by the document transport mechanism unit into confidential documents and unnecessary documents and deposits the classified documents according to an instruction of the disposal process instructing terminal.

10. The system according to claim 9,
wherein the number of options of a process treatment, when the kind of the document instructed and selected by the disposal process instructing terminal is the confidential document, is different from that in a case of the unnecessary document.

11. The system according to claim 10,
wherein the number of options of the process treatment, when the kind of the document instructed and selected by the disposal process instructing terminal is the unnecessary document, is larger than that in a case of the confidential document.

12. The system according to claim 11,
wherein the instruction of the process treatment instructed by the disposal process instructing terminal includes a selection of whether a disposal recording is necessary or unnecessary.

13. The system according to claim 12,
wherein the instruction of the process treatment instructed by the disposal process instructing terminal includes a selection of whether a disposal place is in the system or a transport place.

14. A document disposal management method comprising:
when a document to be disposed of is input to any one of a plurality of disposal document input units, transporting the document in the disposal document input unit to a document transport mechanism unit; and
when the kind of the document to be disposed of and a process treatment thereof are instructed by a disposal process instructing terminal provided on each of the disposal document input units, depositing the document transported by the document transport mechanism unit in order to be disposed of by a document processing mechanism unit according to an instruction of the disposal process instructing terminal.

15. The method according to claim 14,
wherein the instruction of the kind of the document instructed by the disposal process instructing terminal selects one of a confidential document and an unnecessary document.

16. The method according to claim 15,
wherein the number of options of a process treatment, when the kind of the document instructed and selected by the disposal process instructing terminal is the confidential document, is different from that in a case of the unnecessary document.

17. The method according to claim 16,
wherein the number of options of the process treatment, when the kind of the document instructed and selected by the disposal process instructing terminal is the unnecessary document, is larger than that in a case of the confidential document.

18. The method according to claim 17,
wherein the instruction of the process treatment instructed by the disposal process instructing terminal includes a selection of whether computerization is necessary or unnecessary.

19. The method according to claim 18,
wherein the instruction of the process treatment instructed by the disposal process instructing terminal includes a selection of whether a disposal recording is necessary or unnecessary.

20. The method according to claim 19,
wherein the instruction of the kind of the document and the process treatment thereof instructed by the disposal process instructing terminal is selected and input using a display unit and an input unit of a personal computer.
